(19) United States
(12) Patent Application Publication
(10) Pub. No.: US 2026/0073613 A1
(43) Pub. Date: Mar. 12, 2026

(54) METHOD AND DEVICE FOR DYNAMIC PIXEL SHADER WAVE GROUPING

(71) Applicant: Samsung Electronics Co., Ltd., Gyeonggi-do (KR)

(72) Inventors: William David ISENBERG, Lyons, CO (US); Dinesh KUWAR, Fremont, CA (US); Wilson Wai Lun FUNG, Milpitas, CA (US)

(21) Appl. No.: 19/069,765

(22) Filed: Mar. 4, 2025

Related U.S. Application Data
(60) Provisional application No. 63/692,890, filed on Sep. 10, 2024.

(51) Int. Cl. G06T 15/00

(52) U.S. Cl. CPC G06T 15/005

(57) ABSTRACT

A method and device are provided in which pixel information may be assembled into a wave by a pixel wave controller of a graphics processing unit (GPU). The wave includes at least attribute data. The pixel wave controller may send a request to a resource allocation module of the GPU. The request includes at least attribute pointers for the wave. The resource allocation module may compare the attribute pointers to active pointer fields for stored attribute data. The resource allocation module may determine a local data store (LDS) memory allocation for the wave based on the comparison enabling a reduction of an original LDS memory allocation for the wave based on a matching entry in the active pointer fields, and send allocation information based on the LDS memory allocation for issuance of a wave launch message to a wave slot.

### CROSS-REFERENCE TO RELATED APPLICATION

This application claims the priority benefit under 35 U.S.C. §119(e) of U.S. Provisional Application No. 63/692,890, filed on Sep. 10, 2024, the disclosure of which is incorporated by reference in its entirety as if fully set forth herein.

### TECHNICAL FIELD

The disclosure generally relates to a graphics processing unit (GPU). More particularly, the subject matter disclosed herein relates to improvements to pixel shader wave processing in a GPU.

### SUMMARY

Modern GPU architectures include work group processors (WGP), which are made up of multiple wave slots that are used to pass information to short programs (e.g., shader programs) that render graphics data. Specifically, a pixel shader (PS) operating on a single wave slot of the GPU, and initialized with pixel data, determines the appearance of a subset of the pixels on a screen of an electronic device. The wave slot receives input data such as color, attributes, and other properties, and supplies that information to a shader program that computes the color and behavior of each pixel appropriate for that input data.

Input to the wave slot is collected in the pixel wave controller(s) one quad (i.e., 4 pixels in a 2×2 grid) at a time, as it is received from the associated primitive assembler (PA)/scan converter (SC) pipeline. The pixel wave controller may assemble the information into individual workloads (or waves), and may perform wave grouping in which two waves are assembled into a two-wave work group (WG). The assembled workload (e.g., one wave or two waves in a single WG) may then be allocated to specific wave slot(s) within a work group processor (WGP) in a shader array (SA). Once a destination wave slot(s) is determined, individual WGP local data store (LDS) memory initialization writes may be issued. After the LDS is initialized, one wave launch message may be sent, per wave, to each wave slot to which the wave(s) were allocated.

One issue with the above approach is that when performing wave grouping, once the first wave is assembled, its initialization and launch may be delayed until a second wave of a WG is fully assembled. This delay may cause performance degradation. Additionally, the LDS memory can only be shared across two waves that are in a single WG.

However, if waves of a WG are associated with the same primitive (e.g., a basic component used to build a digital object being rendered), attribute data written for both waves may be identical. Since the LDS is a resource shared between all wave slots of a WGP, allocation to any wave slot of a WGP can share initialization data.

Therefore, to overcome these issues, systems and methods are described herein in which PS wave LDS memory resources can be shared across different waves allocated at different times. Individual assembled waves may be launched without delay, even when attempting to group together in order to improve performance. More than two waves may share a single LDS space. If a subsequent PS wave is from the same primitive as a previous wave, it may be allocated and launched to any wave slot of the same WGP without allocating and initializing LDS memory for the subsequent wave, by instead sharing the previously initialized memory. Attribute pointers are used to uniquely identify primitives. Individual pixel waves that result from a common primitive have the same attribute pointer values. Therefore, attribute pointers may be used to identify waves that may share attribute LDS memory.

The above approach improves PS functionality by allowing graphics pixel workloads to be grouped dynamically in such a way that shared resources (i.e., LDS memory) can be shared across those workloads, rather than having one resource per workload. This conserves available resources (e.g., LDS memory) and the power required to initialize the shared resource. By not delaying workload launch to make larger workload groups, launch rate is improved. Accordingly, advantages include improved resource utilization, improved dynamic power utilization, and improved graphics performance under certain conditions.

In an embodiment, a method is provided in which pixel information may be assembled into a wave by a pixel wave controller of a GPU. The wave includes at least attribute data. The pixel wave controller may send a request to a resource allocation module of the GPU. The request includes at least attribute pointers for the wave. The resource allocation module may compare the attribute pointers to active pointer fields for stored attribute data. The resource allocation module may determine an LDS memory allocation for the wave based on the comparison enabling a reduction of an original LDS memory allocation for the wave based on a matching entry in the active pointer fields, and send allocation information based on the LDS memory allocation for issuance of a wave launch message to a wave slot.

In an embodiment, a GPU is provided that includes a pixel wave controller configured to assemble pixel information into a wave, and send a request to a resource allocation module of the GPU. The wave includes at least attribute data, and the request includes at least attribute pointers for the wave. The resource allocation module is configured to compare the attribute pointers to active pointer fields for stored attribute data, determine an LDS memory allocation for the wave based on the comparison enabling a reduction of an original LDS memory allocation for the wave based on a matching entry in the active pointer fields, and send allocation information based on the LDS memory allocation for issuance of a wave launch message to a wave slot.

In an embodiment, an electronic device is provided that includes a processor and a non-transitory computer readable storage medium storing instructions. When executed, the instructions cause the processor to assemble pixel information into a wave including at least attribute data, compare attribute pointers for the wave to active pointer fields for stored attribute data, determine an LDS memory allocation for the wave based on the comparison enabling a reduction of an original LDS memory allocation for the wave based on a matching entry in the active pointer fields, and send allocation information based on the LDS memory allocation for issuance of a wave launch message to a wave slot.

### BRIEF DESCRIPTION OF THE DRAWING

In the following section, the aspects of the subject matter disclosed herein will be described with reference to exemplary embodiments illustrated in the figures, in which:

FIG. 1 is a diagram illustrating an electronic device, according to an embodiment;

FIG. 2 is a diagram illustrating LDS memory allocation for PS waves;

FIG. 3 is a diagram illustrating LDS memory allocation for PS waves, according to an embodiment;

FIG. 4 is a diagram illustrating flow through a PS architecture, according to an embodiment;

FIG. 5 is a flowchart illustrating a method for shader wave processing, according to an embodiment; and

FIG. 6 is a block diagram of an electronic device in a network environment, according to an embodiment.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration. ” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

An electronic device, according to one embodiment, may be one of various types of electronic devices utilizing storage devices (e.g., memory devices). The electronic device may use any suitable storage standard, such as, for example, peripheral component interconnect express (PCIe), nonvolatile memory express (NVMe), NVMe-over-fabric (NVMeoF), advanced extensible interface (AXI), ultra path interconnect (UPI), ethernet, transmission control protocol/Internet protocol (TCP/IP), remote direct memory access (RDMA), RDMA over converged ethernet (ROCE), fibre channel (FC), infiniband (IB), serial advanced technology attachment (SATA), small computer systems interface (SCSI), serial attached SCSI (SAS), Internet wide-area RDMA protocol (iWARP), and/or the like, or any combination thereof. In some embodiments, an interconnect interface may be implemented with one or more memory semantic and/or memory coherent interfaces and/or protocols including one or more compute express link (CXL) protocols such as CXL.mem, CXL.io, and/or CXL.cache, Gen-Z, coherent accelerator processor interface (CAPI), cache coherent interconnect for accelerators (CCIX), and/or the like, or any combination thereof. Any of the memory devices may be implemented with one or more of any type of memory device interface including double data rate (DDR), DDR2, DDR3, DDR4, DDR5, low-power DDR (LPDDRX), open memory interface (OMI), Nvlink high bandwidth memory (HBM), HBM2, HBM3, and/or the like. The electronic devices may include, for example, a portable communication device (e.g., a smart phone), a computer, a portable multimedia device, a portable medical device, a camera, a wearable device, or a home appliance. However, an electronic device is not limited to those described above.

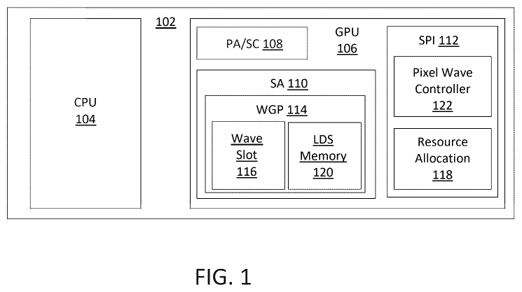

FIG. 1 is a diagram illustrating an electronic device, according to an embodiment. An electronic device 102 may include a central processing unit (CPU) 104 and a GPU 106. The GPU 106 may include a PA/SC pipeline 108, one or more SAs 110, and a shader processor input (SPI) module 112. Each SA 110 may include multiple WGPs 114. Each WGP 114 may include multiple wave slots 116 used by shader programs to process individual waves. In rendering graphics data, the GPU 106 may utilize a resource allocation module 118 of the SPI module 112 to assign resources, such as an LDS memory 120 of the WGP 114, for program initialization data. The process of assigning resources may be referred to as allocation. Specifically, workloads or waves assembled by pixel wave controllers 122 of the SPI module 112 and allocated to a wave slot by the resource allocation module 118 may utilize a common on-chip memory referred to as the LDS memory 120.

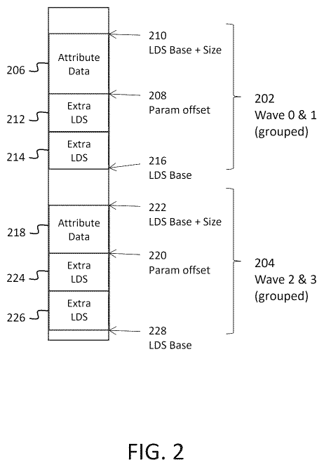

FIG. 2 is a diagram illustrating LDS memory allocation for PS waves. Specifically, FIG. 2 illustrates four PS waves assembled into two groups of two waves each. All data for both waves in a group is assembled before generating the allocation request, which delays the first wave of the group until the second wave of the group is received at pixel wave controller(s).

FIG. 2 illustrates a first group 202 having a first wave and a second wave, and a second group 204 having a third wave and a fourth wave. The first group 202 may include first attribute data 206 for the first wave and the second wave that begins at a first LDS base address plus parameter offset 208 and ends at a first LDS base address plus size 210. An extra LDS allocation 212 for the second wave and an extra LDS allocation 214 for the first wave are contiguous and begin at LDS base address pointer 216 and end at the base address plus parameter offset 208.

The first attribute data 206 may be shared across the first and second waves and may include primitives for the first and second waves. The allocated LDS memory space may be a single block of LDS memory resources that is equal to the sum of the attribute storage and extra LDS space for each wave.

Similarly, the second group 204 may include second attribute data 218 for the third wave and the fourth wave that begins at a second LDS base address plus parameter offset 220 and ends at LDS base address plus size 222. An extra LDS allocation 224 for the fourth wave and an extra LDS allocation 226 for the third wave are contiguous and begin at the LDS base address 228 and ends at the LDS base address plus parameter offset 220. The second attribute data 218 may be shared across the third and fourth waves and may include primitives for the third and fourth waves.

When primitives are sufficiently large, they may be distributed to all pixel wave controllers, and may fill the WGP array. However, each PS wave from such a primitive may share LDS memory space, since the LDS memory is used for attribute initialization and all waves will have the same attributes. Sharing of LDS memory attribute storage across multiple waves may remove many LDS memory initialization writes, since only one LDS memory shared region may be initialized for multiple waves.

According to an embodiment, each wave/workload may be individually launched when ready, without the requirement to delay launch until a subsequent wave/workload is assembled. By launching each wave as it is assembled, there are no launch delays on any assembled waves to reduce performance. By determining if a wave can re-use a previous wave's initialized resource of the LDS memory, the allocation of the resource may be reduced and the power to initialize the subsequent LDS memory allocation is removed.

Accordingly, multiple waves allocated to any wave slot of a WGP may share a single initialized LDS memory space. Up to 64 workloads may be grouped together and share a single LDS memory resource. If allocated PS waves retire, followed by new PS waves associated with the same primitive being launched to the same WGP, the number of waves that share a single initialized LDS memory region may be unlimited.

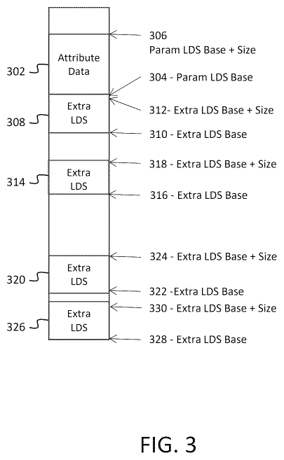

FIG. 3 is diagram illustrating LDS memory allocation for PS waves, according to an embodiment. Each PS wave is allocated when that wave is assembled in a pixel wave controller, rather than delaying it until a second wave is assembled. While the extra LDS memory space is allocated for each wave, attribute data is shared across as many waves as require it. Waves other than PS waves may not have any alteration to the LDS memory allocation/deallocation signaling/logic.

Specifically, FIG. 3 illustrates attribute data 302 for a first wave, a second wave, a third wave, and a fourth wave that begins at a parameter LDS base address 304 and ends at parameter LDS base address plus size 306. The attribute data 302 may include the shared primitives of the first wave, the second wave, the third wave, and the fourth wave. An extra LDS allocation 308 for the first wave begins at a first extra LDS base address 310 and ends at a first extra LDS base address plus size 312. The extra LDS allocation 308 for the first wave is illustrated as being shared along with, and thus, contiguous with the attribute data 302 (i.e., without a delta therebetween).

An extra LDS allocation 314 for the second wave begins at a second extra LDS base address 316 and ends at a second extra LDS base address plus size 318. A delta may exist between the extra LDS allocation 308 and the extra LDS allocation 314. An extra LDS allocation 320 for the third wave begins at a third extra LDS base address 322 and ends at a third extra LDS base address plus size 324. A delta may exist between the extra LDS allocation 314 and the extra LDS allocation 320. An extra LDS allocation 326 for the fourth wave begins at a fourth extra LDS base address 328 and ends at a fourth extra LDS base address plus size 330. A delta may exist between the extra LDS allocation 320 and the extra LDS allocation 326.

The allocation illustrated FIG. 3 includes the new parameter LDS base address pointer 306, however, the tile level signaling of PS wave launch and deallocation does not change. The extra LDS base address bits may be signaled on existing LDS base address fields, including the wave slot returning the extra LDS base during deallocation.

The terms “parameter LDS” and “shared LDS” may be used interchangeably herein. Generally, the term “shared” may refer to new logic structures storing information for parameter LDS base address and wave counts allocated to that LDS memory space.

Dynamic PS wave grouping of FIG. 3 may be of greater benefit for waves associated with large primitives, and it may be assumed that only single primitive waves may be grouped in this fashion. The pixel wave controllers may inspect each wave to ensure that the entire wave is for one and only one primitive. This may limit the required comparators in the logic of this feature to only requiring equality detection on three pointers.

All PS waves may be treated as being ungrouped and as individual waves without grouping. Only a resource allocation (RA) module may track the LDS memory base addresses which are re-used across multiple waves. Deallocation may only occur when all waves that were allocated using the same LDS base address have issued “wave done” messages.

Although the parameter LDS base address used for attribute initialization can be shared, when extra LDS is enabled, the additional LDS space required may be allocated uniquely for each wave. If a wave does not match pointers in use anywhere in the WGP array, then a new parameter LDS base address and any required extra LDS space may be allocated as a contiguous unit, as shown and described with respect to FIG. 2. New logic may break this allocation into the required two regions, generating an independent parameter LDS base address and extra LDS base address.

Since the parameter LDS region may be allocated by a previous wave, the parameter and extra LDS allocations may not necessarily be contiguous. Therefore, this may require separate LDS base addresses for each region to be signaled to the shader program as part of the wave launch message issued by an SPI module.

The parameter LDS base address may only be allocated when incoming pointers do not match an active parameter LDS base address entry. Therefore, the size of the LDS memory space allocated on any given wave may be either the full space required bay a pixel wave (e.g., as indicated by the pixel wave controller) or may only include the extra LDS space. The size of LDS to be allocated may be determined on a per-WGP basis during a fit-checking stage of allocation processing.

When parameter LDS memory space is allocated, the LDS memory write controllers may be signaled to appropriately initialize the attribute data. When PS waves are allocated and there is a previous parameter LDS memory allocation, only the extra LDS memory space required by the wave may be allocated, and the LDS memory write controllers may not be signaled, since the LDS memory may already be initialized, and subsequent initialization may not be required.

Deallocation of PS waves may be augmented to allow for the parameter LDS memory space to be deallocated only when all waves using that shared region are done. Extra LDS memory space may be deallocated utilizing the existing signaling infrastructure as each wave is retired. Existing hardware mechanisms are not able to identify waves sharing LDS memory unless they are in the same allocation request.

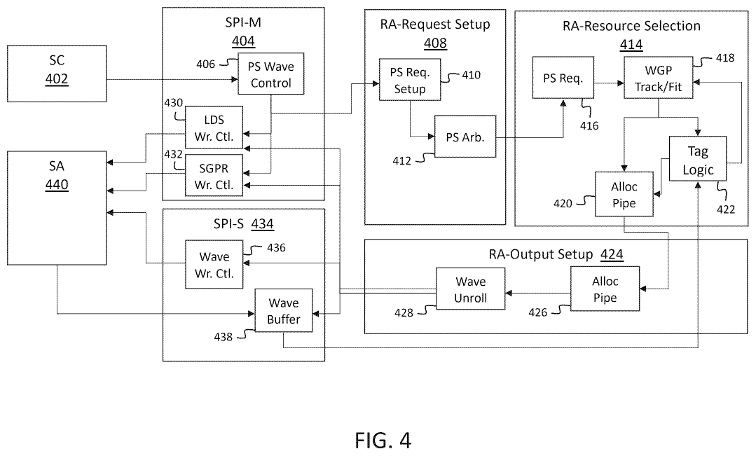

FIG. 4 is a diagram illustrating flow through a PS architecture, according to an embodiment.

An SC 402 may provide input to a SPI-master (SPI-M) module 404. The SPI-M module 404 includes a pixel wave controller 406 that assembles a PS wave based on the input. When fully assembled, the pixel wave controller 406 may determine whether the wave is for a single primitive. If the wave is for a single primitive, the pixel wave controller 406 may enable dynamic grouping, and include that in the request to the RA module. The pixel wave controller 406 may also include pointers for the wave in the request to the RA module.

An RA request setup module 408 may receive the request in a PS request setup module 410 for the associated pixel wave controller 406, and may pass the request to a PS arbitration module 412. The logic comparing inputs to previous requests may be augmented to include the new fields identified above.

An RA resource selection module 414 may receive the request at a PS request module 416 and a WGP tracking/fit-check module 418. Each WGP tracking/fit-check module 418 may compare the incoming pointers against all active parameter base address pointer fields. If there is a match, the tag of the matching entry may be stored for use by that PS requester, and the LDS memory allocation requirement may be reduced by the parameter size. If no matching entry is found, the next tag in sequence may be used, and the full LDS memory size for the wave may be allocated. Since searching the tag memory for matching attribute pointers may be concurrently required for both allocation and deallocation, the attribute pointer and allocated count values may not be implemented in memory instances and may be implemented in sequential and combinational logic.

If there is a valid tag for the request, a wave counter may be incremented, the parameter base address may be used for the allocated wave, and the allocated LDS memory may be used for the extra base address if appropriate. If no valid tag exists, the next tag in sequence of tags for parameter base address pointer fields be initialized with the allocated base address, the attribute pointers, a wave count of one, etc. The extra base address may be calculated by adding the parameter depth to the allocated base address.

Allocation information may be carried through an allocation pipe module 420 with the additions of the extra LDS base address, the parameter LDS tag ID, and an LDS initialize enable flag. Tag entries may be updated at a tag logic module 422 by activating a new entry or incrementing an active wave counter of an existing entry.

An RA output setup module 424 may receive the allocation information at an allocation pipe module 426, which forwards the allocation to a wave unroll module 428.

The SPI-M module 404 may receive the allocation information at an LDS write controller 430 and a scalar general purpose register (SGPR) write controller 432. If “LDS initialize enable” is not asserted in the allocation information, the LDS write may be dropped.

An SPI-slave (SPI-S) module 434 may receive the allocation information at a wave write controller 436. The extra base address may be appended to a new wave message. If “LDS initialize enable” is asserted in the allocation information, the new wave message may wait for the LDS write controller 430 to signal completion before launching the wave. If “LDS initialize enable” is not asserted, no signal from the LDS write controller 430 will be received, and as such, the launch of the wave will not be delayed.

The SPI-S module 434 may also receive the allocation information at a wave buffer 438, where the shared tag from the allocation information may be stored in a memory.

An SA 440 may include WPG modules, and each WPG module may include wave slots, as described above with respect to FIG. 1. A shader program operating on a wave slot may initialize vector general purpose registers (VGPRs) from the initialized LDS memory using the shared LDS base address, and may operate using the extra LDS base address. Upon completion, the shader program operating on a wave slot may issue a deallocation message that may contain the extra base address and depth in the wave done message.

The wave buffer 438 may receive the wave done message and may use the message to fetch a shared tag that is appended to the deallocation message sent to the RA.

The tag logic module 422 of the RA resource selection module 414 may receive the wave done message. The “shared/parameter” tag may be used to decrement the wave count of the associated shared entry. If the wave count is decremented to zero, the parameter LDS space may be added to the deallocation message. If the tag matches any active per-packer request logic, that tag usage may also be cleared when the wave count is decremented to zero by the deallocation message.

The tag logic module 422 may forward the updated deallocation message to the appropriate logic of the WGP track/fit module 420. This message may deallocate all resources normally.

PS waves may be allocated prior to determining which wave slot IDs will be used by the individual waves of a request. Thus, storing a parameter LDS base address may be in a new memory that is equal in number to the number of wave slot IDs, but is not addressed by the allocated wave slot IDs. Instead, allocated parameter LDS base addresses may be stored in a memory identified by a tag generated when the shared LDS memory space is allocated. This shared base address storage tag may identify the entry storing the shared LDS base address. The tag (e.g., tag ID bits) may be passed through the existing pipeline from the tag logic module 422 of the RA resource selection module 414, through the first allocation pipeline module 420, the second allocation pipeline 426, and the wave unroll module 428, to be stored in the wave buffer 438 of the SPI-S module 434 on allocation. During de-allocation, the tag (or tag ID bits) may be fetched from the wave buffer 438 when receiving a wave done message from an interface and passed to the WGP tracking/fit-check module 418 of the RA resource selection module 414, where they are used to identify a tag entry for deallocation.

Tag status may have states including empty/available, grouping waves, and/or waiting for wave done.

Accordingly, at least two tag status bits may be required. These bits may change dynamically based on multiple conditions. Therefore, these bits may be implemented in sequential logic.

Each entry may count the number of waves sharing the LDS base address. Since all 64 wave slots of a WGP may share the LDS memory space concurrently, the counter may be seven bits wide. If the counter is designed to be zero ordered, one bit may be removed.

The storage of parameter LDS base addresses may be sufficiently deep to handle the case in which every wave slot is for a unique primitive (i.e., no sharing), and all wave slots are allocated to PS waves. Therefore, there may be one entry for each wave slot ID in a WGP, across all WGPs in an SE. For M4 this is 64 waves per WGP, 4 WGPs per SE=256 entries.

Each entry of a content-addressable memory (CAM) may contain a storage for pointers (used to uniquely identify a primitive), a wave counter that counts the number of waves of the same primitive which are sharing LDS space, and an entry status field. Storage for LDS base address information may be required, however this memory may be in a different physical location than the rest of the CAM logic.

PS waves may be received by the RA resource selection module 414 on one of the two request inputs from the RA request setup module 408. Further, there may be only one potential request being arbitrated per PS wave control module 406. As such, a single input path may be augmented to determine if a parameter LDS space is possible for each received wave. The WPG tracking/fit-check module 418 for each of the PS waves may be augmented for this feature.

A request may determine if an existing LDS base address is for the same primitive by matching the pointers supplied with the allocation request to all stored and actively grouped pointers. Based on this detection, the size of the required LDS memory allocation may be selected (e.g., parameter storage plus extra LDS, or only extra LDS). If this solution is not practical, then two fit checks may be performed concurrently, one for each of the sizes. Based on the pointer match detection, one fit check or the other may be selected.

Each WGP tracking/fit-check module 418 may store on a per-wave controller basis, the tag ID associated with a pixel wave controller, and a bit indicating if that tag is active. The WGP tracking/fit-check module 418 may be updated when a new request is received from the PS request setup module 410 of the RA request setup module 408. The WGP tracking/fit-check module 418 may also be updated during the processing of an allocation. It should accurately represent what the PS request can/will do should an allocation occur. During allocation, it may be possible for multiple packers to be utilizing the same pointers. In such a case, the allocation processing may update all packers utilizing the same pointers to indicate they are able to share the same portion of LDS memory.

Dynamic PS wave grouping may be disabled in active entries when a deallocation is signaled to a PC manager, with the exception of any entry to which any packer is actively grouping waves. This may be done to prevent subsequent PC re-allocation and reuse from potentially being grouped with different primitives from previous LDS allocations.

Parameter LDS base address and depth fields may be passed through the allocation/deallocation signaling interfaces. PS waves with extra LDS may signal LDS deallocation from the wave slot to the SPI-S module 434.

A software programmable register may add a bit (bit 24) that will disable a dynamic PS wave grouping function. When this bit is asserted, the pixel wave controller will not assert the dynamic PS wave grouping enable signal when generating allocation requests to the RA. When this bit is not asserted, the dynamic PS wave grouping function (e.g., grouping two waves into a single PS allocation request) is disabled.

If both types of wave grouping are enabled, waves will not be grouped in the pixel wave controllers, and single primitive waves will be signaled to the RA for grouping using this mechanism.

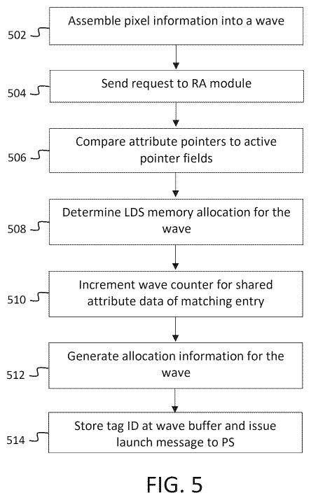

FIG. 5 is a flowchart illustrating a method for shader wave processing, according to an embodiment. At 502, pixel information may be assembled into a wave by a pixel wave controller of a GPU. The wave may include at least attribute data.

At 504, the pixel wave controller may send a request to a resource allocation module of the GPU. The request may include at least attribute pointers for the wave. When the wave is for a single primitive, the request may include an indication enabling dynamic grouping.

At 506, the resource allocation module may compare the attribute pointers to active pointer fields for stored attributed data. In case that the active pointer fields include a matching entry based on the comparison a tag ID of the matching entry may be stored.

At 508, the resource allocation module may determine an LDS memory allocation for the wave based on the comparison. In case that the active pointer fields include a matching entry, an original LDS allocation for the wave may be reduced by a size of the attribute data.

At 510, the resource allocation module may increment a wave counter for shared attribute data of the matching entry. At 512, the resource allocation module may generate allocation information for the wave. The shared attribute data may be used for the wave and the LDS allocation may be used for an extra base address of the wave. The allocation information may include at least the extra base address and the tag ID.

At 514, a wave buffer may receive the allocation information and store a tag ID, and a wave write controller may receive the allocation information and issue a launch message to a wave slot.

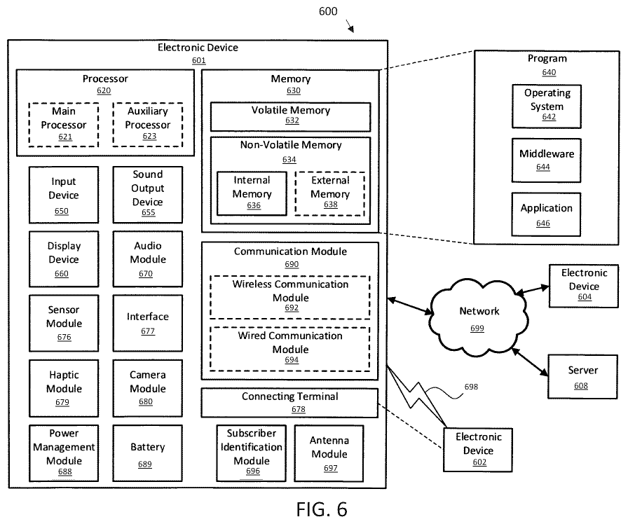

FIG. 6 is a block diagram of an electronic device in a network environment 600, according to an embodiment.

Referring to FIG. 6, an electronic device 601 in a network environment 600 may communicate with an electronic device 602 via a first network 698 (e.g., a short-range wireless communication network), or an electronic device 604 or a server 608 via a second network 699 (e.g., a long-range wireless communication network). The electronic device 601 may communicate with the electronic device 604 via the server 608. The electronic device 601 may include a processor 620, a memory 630, an input device 650, a sound output device 655, a display device 660, an audio module 670, a sensor module 676, an interface 677, a haptic module 679, a camera module 680, a power management module 688, a battery 689, a communication module 690, a subscriber identification module (SIM) card 696, or an antenna module 697. In one embodiment, at least one (e.g., the display device 660 or the camera module 680) of the components may be omitted from the electronic device 601, or one or more other components may be added to the electronic device 601. Some of the components may be implemented as a single integrated circuit (IC). For example, the sensor module 676 (e.g., a fingerprint sensor, an iris sensor, or an illuminance sensor) may be embedded in the display device 660 (e.g., a display).

The processor 620 may execute software (e.g., a program 640) to control at least one other component (e.g., a hardware or a software component) of the electronic device 601 coupled with the processor 620 and may perform various data processing or computations.

As at least part of the data processing or computations, the processor 620 may load a command or data received from another component (e.g., the sensor module 676 or the communication module 690) in volatile memory 632, process the command or the data stored in the volatile memory 632, and store resulting data in non-volatile memory 634. The processor 620 may include a main processor 621 (e.g., a central processing unit (CPU) or an application processor (AP)), and an auxiliary processor 623 (e.g., a graphics processing unit (GPU), an image signal processor (ISP), a sensor hub processor, or a communication processor (CP)) that is operable independently from, or in conjunction with, the main processor 621. Additionally or alternatively, the auxiliary processor 623 may be adapted to consume less power than the main processor 621, or execute a particular function. The auxiliary processor 623 may be implemented as being separate from, or a part of, the main processor 621.

The auxiliary processor 623 may control at least some of the functions or states related to at least one component (e.g., the display device 660, the sensor module 676, or the communication module 690) among the components of the electronic device 601, instead of the main processor 621 while the main processor 621 is in an inactive (e.g., sleep) state, or together with the main processor 621 while the main processor 621 is in an active state (e.g., executing an application). The auxiliary processor 623 (e.g., an image signal processor or a communication processor) may be implemented as part of another component (e.g., the camera module 680 or the communication module 690) functionally related to the auxiliary processor 623.

The memory 630 may store various data used by at least one component (e.g., the processor 620 or the sensor module 676) of the electronic device 601. The various data may include, for example, software (e.g., the program 640) and input data or output data for a command related thereto. The memory 630 may include the volatile memory 632 or the non-volatile memory 634. Non-volatile memory 634 may include internal memory 636 and/or external memory 638.

The program 640 may be stored in the memory 630 as software, and may include, for example, an operating system (OS) 642, middleware 644, or an application 646.

The input device 650 may receive a command or data to be used by another component (e.g., the processor 620) of the electronic device 601, from the outside (e.g., a user) of the electronic device 601. The input device 650 may include, for example, a microphone, a mouse, or a keyboard.

The sound output device 655 may output sound signals to the outside of the electronic device 601. The sound output device 655 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 660 may visually provide information to the outside (e.g., a user) of the electronic device 601. The display device 660 may include, for example, a display, a hologram device, or a projector and control circuitry to control a corresponding one of the display, hologram device, and projector. The display device 660 may include touch circuitry adapted to detect a touch, or sensor circuitry (e.g., a pressure sensor) adapted to measure the intensity of force incurred by the touch.

The audio module 670 may convert a sound into an electrical signal and vice versa. The audio module 670 may obtain the sound via the input device 650 or output the sound via the sound output device 655 or a headphone of an external electronic device 602 directly (e.g., wired) or wirelessly coupled with the electronic device 601.

The sensor module 676 may detect an operational state (e.g., power or temperature) of the electronic device 601 or an environmental state (e.g., a state of a user) external to the electronic device 601, and then generate an electrical signal or data value corresponding to the detected state. The sensor module 676 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 677 may support one or more specified protocols to be used for the electronic device 601 to be coupled with the external electronic device 602 directly (e.g., wired) or wirelessly. The interface 677 may include, for example, a high-definition multimedia interface (HDMI), a universal serial bus (USB) interface, a secure digital (SD) card interface, or an audio interface.

A connecting terminal 678 may include a connector via which the electronic device 601 may be physically connected with the external electronic device 602. The connecting terminal 678 may include, for example, an HDMI connector, a USB connector, an SD card connector, or an audio connector (e.g., a headphone connector).

The haptic module 679 may convert an electrical signal into a mechanical stimulus (e.g., a vibration or a movement) or an electrical stimulus which may be recognized by a user via tactile sensation or kinesthetic sensation. The haptic module 679 may include, for example, a motor, a piezoelectric element, or an electrical stimulator.

The camera module 680 may capture a still image or moving images. The camera module 680 may include one or more lenses, image sensors, image signal processors, or flashes. The power management module 688 may manage power supplied to the electronic device 601. The power management module 688 may be implemented as at least part of, for example, a power management integrated circuit (PMIC).

The battery 689 may supply power to at least one component of the electronic device 601. The battery 689 may include, for example, a primary cell which is not rechargeable, a secondary cell which is rechargeable, or a fuel cell.

The communication module 690 may support establishing a direct (e.g., wired) communication channel or a wireless communication channel between the electronic device 601 and the external electronic device (e.g., the electronic device 602, the electronic device 604, or the server 608) and performing communication via the established communication channel. The communication module 690 may include one or more communication processors that are operable independently from the processor 620 (e.g., the AP) and supports a direct (e.g., wired) communication or a wireless communication. The communication module 690 may include a wireless communication module 692 (e.g., a cellular communication module, a short-range wireless communication module, or a global navigation satellite system (GNSS) communication module) or a wired communication module 694 (e.g., a local area network (LAN) communication module or a power line communication (PLC) module). A corresponding one of these communication modules may communicate with the external electronic device via the first network 698 (e.g., a short-range communication network, such as BLUETOOTH™, wireless-fidelity (Wi-Fi) direct, or a standard of the Infrared Data Association (IrDA)) or the second network 699 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 692 may identify and authenticate the electronic device 601 in a communication network, such as the first network 698 or the second network 699, using subscriber information (e.g., international mobile subscriber identity (IMSI)) stored in the subscriber identification module 696.

The antenna module 697 may transmit or receive a signal or power to or from the outside (e.g., the external electronic device) of the electronic device 601. The antenna module 697 may include one or more antennas, and, therefrom, at least one antenna appropriate for a communication scheme used in the communication network, such as the first network 698 or the second network 699, may be selected, for example, by the communication module 690 (e.g., the wireless communication module 692). The signal or the power may then be transmitted or received between the communication module 690 and the external electronic device via the selected at least one antenna.

Commands or data may be transmitted or received between the electronic device 601 and the external electronic device 604 via the server 608 coupled with the second network 699. Each of the electronic devices 602 and 604 may be a device of a same type as, or a different type, from the electronic device 601. All or some of operations to be executed at the electronic device 601 may be executed at one or more of the external electronic devices 602, 604, or 608. For example, if the electronic device 601 should perform a function or a service automatically, or in response to a request from a user or another device, the electronic device 601, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 601. The electronic device 601 may provide the outcome, with or without further processing of the outcome, as at least part of a reply to the request. To that end, a cloud computing, distributed computing, or client-server computing technology may be used, for example.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

What is claimed is:

1. A method comprising:
assembling pixel information into a wave by a pixel wave controller of a graphics processing unit (GPU), wherein the wave comprises at least attribute data;
sending, by the pixel wave controller, a request to a resource allocation module of the GPU, wherein the request comprises at least attribute pointers for the wave;
comparing, by the resource allocation module, the attribute pointers to active pointer fields for stored attribute data;
determining, by the resource allocation module, a local data store (LDS) memory allocation for the wave based on the comparison enabling a reduction of an original LDS memory allocation for the wave based on a matching entry in the active pointer fields; and
sending, by the resource allocation module, allocation information based on the LDS memory allocation for issuance of a wave launch message to a wave slot.

2. The method of claim 1, further comprising:
determining, by the pixel wave controller, that the wave is for a single primitive,
wherein the request comprises an indication enabling dynamic pixel wave grouping.

3. The method of claim 1, further comprising:
in case that the active pointer fields comprise the matching entry based on the comparison, storing a tag identifier (ID) of the matching entry,
wherein determining the LDS memory allocation comprises reducing the original LDS memory allocation for the wave by a size of the attribute data.

4. The method of claim 3, further comprising:
incrementing, by the resource allocation module, a wave counter for shared attribute data of the matching entry; and
generating, by the resource allocation module, the allocation information for the wave, wherein the shared attribute data is used for the wave and the LDS memory allocation is used for an extra base address of the wave.

5. The method of claim 4, wherein the allocation information comprises at least the extra base address and the tag ID.

6. The method of claim 5, further comprising:
sending, by the resource allocation module, the allocation information to a wave write controller and a wave buffer of the GPU;
storing the tag ID at the wave buffer; and
issuing, by the wave write controller, the wave launch message to the wave slot based on the allocation information.

7. The method of claim 6, further comprising:
receiving, by the wave buffer, a message from the wave slot upon completing processing of the wave;
fetching, by the wave buffer, the stored tag ID for the wave based on the message;
appending, by the wave buffer, the tag ID to the message;
sending the message from the wave buffer to the resource allocation module;
decrementing, by the resource allocation module, the wave counter for shared attribute data based on the message; and
deallocating, by the resource allocation module, the LDS memory allocation of the wave.

8. A graphics processing unit (GPU) comprising:
a pixel wave controller configured to assemble pixel information into a wave, and send a request to a resource allocation module of the GPU, wherein the wave comprises at least attribute data and the request comprises at least attribute pointers for the wave; and
the resource allocation module configured to compare the attribute pointers to active pointer fields for stored attribute data, determine a local data store (LDS) memory allocation for the wave based on the comparison enabling a reduction of an original LDS memory allocation for the wave based on a matching entry in the active pointer fields, and send allocation information based on the LDS memory allocation for issuance of a wave launch message to a wave slot.

9. The GPU of claim 8, wherein:
the pixel wave controller is further configured to determine that the wave is for a single primitive; and
the request comprises an indication enabling dynamic grouping.

10. The GPU of claim 8, wherein, in case that the active pointer fields comprise the matching entry based on the comparison:
the resource allocation module is further configured to store a tag identifier (ID) of the matching entry; and
the LDS memory allocation is determined by reducing the original LDS memory allocation for the wave by a size of the attribute data.

11. The GPU of claim 10, wherein the resource allocation module is further configured to:
increment a wave counter for shared attribute data of the matching entry; and
generate the allocation information for the wave, wherein the shared attribute data is used for the wave and the LDS memory allocation is used for an extra base address of the wave.

12. The GPU of claim 11, wherein the allocation information comprises at least the extra base address and the tag ID.

13. The GPU of claim 12, further comprising
a wave buffer configured to receive the allocation information from the resource allocation module and store the tag ID; and
a wave write controller configured to receive the allocation information from the resource allocation module and issue the wave launch message to the wave slot based on the allocation information.

14. The GPU of claim 13, wherein:
the wave buffer is further configured to receive a message from the wave slot upon completing processing of the wave, fetch the stored tag ID for the wave based on the message, append the tag ID to the message, and send the message to the resource allocation module; and
the resource allocation module is further configured to decrement the wave counter for the shared attribute data based on the message, and deallocate the LDS memory allocation of the wave.

15. An electronic device comprising:
a processor; and
a non-transitory computer readable storage medium storing instructions that, when executed, cause the processor to:
assemble pixel information into a wave comprising at least attribute data;
compare attribute pointers for the wave to active pointer fields for stored attribute data;
determine a local data store (LDS) memory allocation for the wave based on the comparison enabling a reduction of an original LDS memory allocation for the wave based on a matching entry in the active pointer fields; and
send allocation information based on the LDS memory allocation for issuance of a wave launch message to a wave slot.

16. The electronic device of claim 15, wherein the instructions further cause the processor to:
determine that the wave is for a single primitive, wherein the request comprises an indication enabling dynamic pixel wave grouping.

17. The electronic device of claim 15, wherein, in case that the active pointer fields comprise the matching entry based on the comparison:
the instructions further cause the processor to store a tag identifier (ID) of the matching entry; and
in determining the LDS memory allocation, the instructions further cause the processor to reduce the original LDS memory allocation for the wave by a size of the attribute data.

18. The electronic device of claim 17, wherein the instructions further cause the processor to:
increment a wave counter for shared attribute data of the matching entry; and
generate the allocation information for the wave, wherein the shared attribute data is used for the wave and the LDS memory allocation is used for an extra base address of the wave,
wherein the allocation information comprises at least the extra base address and the tag ID.

19. The electronic device of claim 18, wherein the instructions further cause the processor to:
store the tag ID at a wave buffer; and
issue the wave launch message to the wave slot based on the allocation information.

20. The electronic device of claim 19, wherein the instructions further cause the processor to:
fetch the stored tag ID for the wave from the wave buffer based on completing processing of the wave at the wave slot;
decrement the wave counter for shared attribute data based on the message; and
deallocate the LDS memory allocation of the wave.
